(19) United States
(12) Patent Application Publication
(10) Pub. No.: US 2024/0140713 A1
(43) Pub. Date: May 2, 2024

(54) INFORMATION PROCESSING DEVICE, INFORMATION PROCESSING METHOD, COMPUTER PROGRAM PRODUCT, AND INFORMATION PROCESSING SYSTEM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Hideyuki AISU, Kawasaki (JP); Shizu SAKAKIBARA, Kawasaki (JP); Takufumi YOSHIDA, Funabashi (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 18/456,825

(22) Filed: Aug. 28, 2023

(30) Foreign Application Priority Data
Oct. 28, 2022 (JP) 2022-173617

(51) Int. Cl. B65G 1/137; G06Q 10/0875

(52) U.S. Cl. CPC B65G 1/1373; G06Q 10/0875

(57) ABSTRACT

According to an embodiment, an information processing device includes one or more hardware processors configured to, based on a plurality of pieces of rack data including first identification information of one or more kinds of products housed in each of a plurality of racks, determine: a processing sequence of a plurality of pieces of order data including second identification information of one or more kinds of products to be picked from at least part of the plurality of racks; and one or more of the plurality of racks for picking a product identified by the second identification information for each of the plurality of pieces of order data.

### CROSS-REFERENCE TO RELATED APPLICATIONS

This application is based upon and claims the benefit of priority from Japanese Patent Application No. 2022-173617, filed on Oct. 28, 2022; the entire contents of which are incorporated herein by reference.

### FIELD

An embodiment described herein generally relates to an information processing device, an information processing method, a computer program product, and an information processing system.

### BACKGROUND

Semi-automated Fulfillment centers like as Amazon is known, in which automated guided vehicles (AGV) bring racks of inventory to their associates who are at workstations either picking or stowing items.

As for such rack transfer systems, it is assumed in many cases that each order is added sequentially in real time. In other words, it is not usually anticipated that a large number of orders that can be changed in the processing sequence thereof are given to the system at a same timing.

### BRIEF DESCRIPTION OF THE DRAWINGS

FIG. 1 is a diagram illustrating an overview of a configuration of an information processing system according to an embodiment;

FIG. 2 is a block diagram of an information processing device according to the present embodiment;

FIG. 3 is a diagram illustrating an example of an index to be generated;

FIG. 4 is a diagram illustrating an example of hierarchical clusters to be generated;

FIG. 5 is a diagram illustrating an example of orders rearranged according to a processing sequence;

FIG. 6 is a flowchart illustrating sequence determination processing according to the present embodiment;

FIG. 7 is a diagram for describing a specific example of processing when determining in advance racks to be used;

FIG. 8 is a diagram for describing a comparative example where racks to be used are not determined in advance; and

FIG. 9 is a hardware configuration diagram of the information processing device according to the present embodiment.

### DETAILED DESCRIPTION

According to an embodiment, an information processing device includes one or more hardware processors configured to, based on a plurality of pieces of rack data including first identification information of one or more kinds of products housed in each of a plurality of racks, determine: a processing sequence of a plurality of pieces of order data including second identification information of one or more kinds of products to be picked from at least part of the plurality of racks; and one or more of the plurality of racks for picking a product identified by the second identification information for each of the plurality of pieces of order data.

With reference to the accompanying drawings, a preferable embodiment of an information processing device according to an embodiment will be described in detail hereinafter. The present embodiment can be applied to a logistics system using a rack transfer warehouse, for example.

As described above, in a conventional rack transfer system, orders are selected as picking targets sequentially as they are generated.

In the meantime, in a logistics system mainly targeted at Business to Business (B2B), for example, all orders to be processed within a certain period of time (for example, a unit of one day) may be given in advance. In such cases, the processing sequence of a plurality of orders can be changed as long as it is before the shipping deadline. For example, by appropriately rearranging the order processing sequence in advance and determining in advance a rack assigned to each of the orders, it may be possible to improve the ratio at which products assigned to a plurality of orders are picked from a single rack (simultaneous picking ratio) and improve the efficiency of rack transfer work and picking work. Conventionally, however, there has been no concern regarding a function such as rearranging the order processing sequence of a large order in advance and determining the racks to be used in each of the orders so as to improve the work efficiency of the system as a whole.

Therefore, in the present embodiment, when a plurality of pieces of order data as information of unprocessed orders are given, the processing sequence of the orders and the racks to be used in each of the orders are determined so as to improve the simultaneous picking ratio by referring to a plurality of pieces of rack data regarding a plurality of racks each housing one or more kinds of products. Since there is a one-to-one correspondence between the order data and the order, determining the processing sequence of the orders corresponds to determining the processing sequence of the order data. Similarly, processing for the orders can be rephrased as processing for the order data.

Rack data is data that includes a rack ID that is information identifying a rack, and identification information (first identification information) for one or more kinds of products that are currently housed on each rack as inventory. The rack data includes identification information indicating the kind of each product that makes up a set of products (product set) housed on the rack, for example.

Order data is data that includes an order ID that is information identifying an order, and identification information (second identification information) of one or more kinds of products to be picked from at least part of a plurality of racks. The order data represents, for example, a unit of shipping instruction for each product to be packed in a same housing container for a same destination.

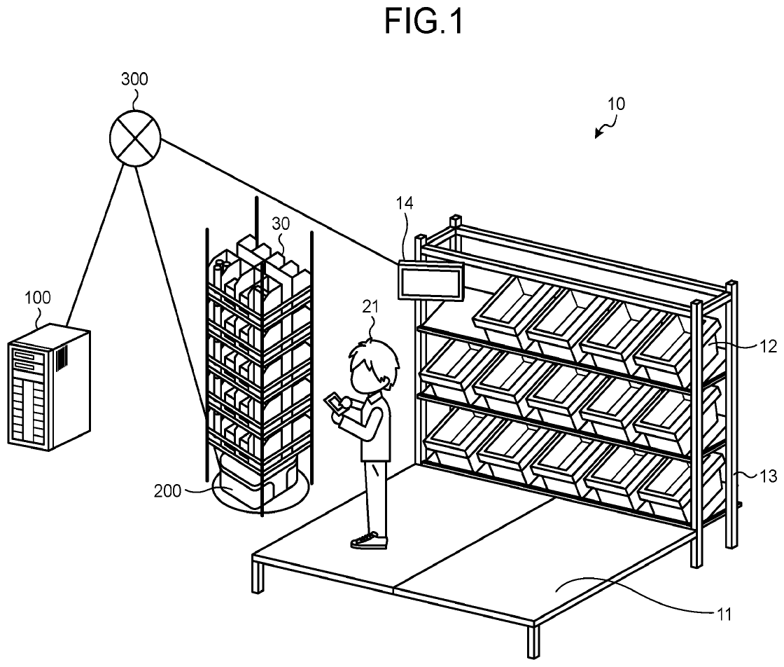

FIG. 1 is a diagram illustrating an overview of a configuration of an information processing system 10 (an example of the rack transfer system) according to the present embodiment. As illustrated in FIG. 1, the information processing system 10 includes an information processing device 100, a transfer device 200, a movable rack 30, a work station 11, a plurality of housing containers 12, a work rack 13, a display 14, and a network 300.

The work station 11 indicates the work place where picking is performed by a worker 21. While only one work station 11 is illustrated in FIG. 1, the information processing system 10 may include a plurality of work stations 11.

The rack 13 can accommodate the housing containers 12. The housing containers 12 correspond to each of a plurality of orders, for example. On the rack 13, the housing containers 12 each corresponding to at least part of a plurality of pieces of order data are placed. The display 14 is a display device for displaying information such as work instructions output from the information processing device 100, for example.

The transfer device 200 is a device for moving (transferring) the rack 30 to the work station 11, which is an AGV, for example. As described, the rack 30 is movable to the work station 11. While only one rack 30 is illustrated in FIG. 1, a plurality of the racks 30 are prepared in the information processing system 10, and the rack 30 selected according to the determined order processing sequence is moved to the work station 11. In a case of moving the rack by the worker 21, the transfer device 200 may not need to be provided. The rack 30 has a plurality of partitions, for example, and is capable of housing a plurality of kinds of products.

The network 300 is a network connecting the information processing device 100, the transfer device 200, and the display 14. The network 300 may be any form of network, including the Internet and a local area network (LAN). The network 300 may be a wireless network, a wired network, or a mixture of wireless and wired networks.

As illustrated in FIG. 1, the housing containers 12 for work corresponding to a plurality of orders are placed on the rack 13, and the worker 21 can perform picking for the orders in parallel. Note that picking may be performed by a picking robot or the like instead of the worker 21. Picking for each of the housing containers 12 is completed, when each of the products to be packed is placed thereinto. Completed orders (housing containers) are treated as completed and are sequentially removed from the work station 11, and the housing container 12 corresponding to the next order is put in.

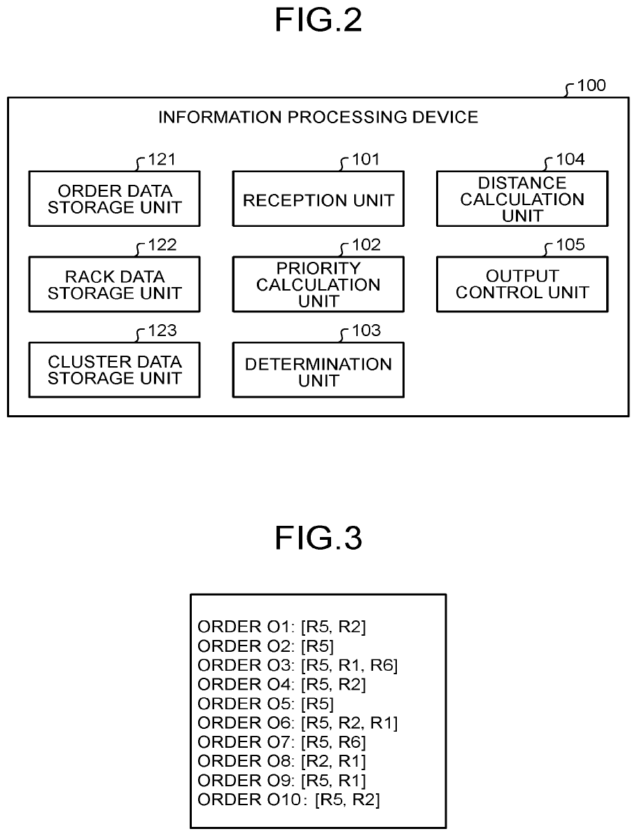

FIG. 2 is a block diagram illustrating an example of the configuration of the information processing device 100 according to the present embodiment. As illustrated in FIG. 1, the information processing device 100 includes a reception unit 101, a priority calculation unit 102, a determination unit 103, a distance calculation unit 104, an output control unit 105, an order data storage unit 121, a rack data storage unit 122, and a cluster data storage unit 123.

The reception unit 101 receives input of various kinds of data used in the information processing device 100. For example, the reception unit 101 receives a plurality of pieces of order data and a plurality of pieces of rack data to be processed. The order data and the rack data may be generated by any method, and may be generated by external systems such as a system that receives orders and a system that manages inventory of products, for example. While the method for inputting each data may be any method, it is possible to use a method that receives the data from an external system via the network 300, for example.

The order data includes at least an order ID and identification information of the products included in the order. The order IDs may be indicated as order O1, order O2, order O3, and so on, for example. The identification information of products may be indicated as product A, product B, product C, and so on, for example. Note that Information included in the order data is not limited thereto. For example, the order data may include the number and quantity of each product.

The rack data includes at least a rack ID and identification information of the products to be housed on the rack. The rack ID may be indicated as rack R1, rack R2, rack R3, and so on, for example. Note that Information included in the rack data is not limited thereto. For example, the rack data may include the number of pieces for each product and housing position information of the product regarding which side of the rack and in which partition the product is housed.

The reception unit 101 may receive data other than the order data and the rack data, such as product data including detailed information about each product (size, packing style, and the like), for example, as supplementary input data.

The priority calculation unit 102 calculates the priority for each of the racks. The priority is used by the determination unit 103 when determining the racks to be assigned to each of the orders. The priority is calculated such that the value becomes larger for the rack where picking work can be performed more efficiently, for example. For example, the priority calculation unit 102 calculates the priority in a following method.
From the identification information of the products included in the rack data, create a list of products included in any of a plurality of pieces of order data, that is, a list (unassigned product list) of the products (unassigned products) that are not assigned despite of being requested in the orders.
Calculate the priority (product priority) for each of the products regarding the unassigned products. The priority for each of the products is, for example, the number of orders including the corresponding product, that is, the number of orders requesting the product (the number of assigned orders).
For each rack, the total value of the product priorities included in the unassigned product list is calculated as the priority of the rack (rack priority).

Based on the calculated priority of each rack, the determination unit 103 determines, for a plurality of pieces of order data, one or more racks for picking the product among the racks that house the products of identification information that matches the identification information of the products included in the order data.

For example, the determination unit 103 assumes that all orders can be processed in parallel (parallel picking is possible for the housing containers 12 corresponding to all orders), and iterates to sequentially select the rack of the highest simultaneous picking ratio, that is, the rack of the highest priority calculated by the priority calculation unit 102, to determine the racks to be used (assigned) for each order and the calling sequence of the racks regarding each of the orders.

The determination unit 103 also generates, for each order data, an index indicating the rack determined as the rack where the product is to be picked. The index is information that includes the rack ID of one or more racks where the product is to be picked, for example. Details of an index generation method will be described later.

The distance calculation unit 104 calculates the distances between a plurality of indexes respectively generated for the plurality of pieces of order data. Details of a distance calculation method will be described later.

Furthermore, based on the rack data, the determination unit 103 determines the processing sequence of the plurality of pieces of order data such that the ratio at which products assigned to the plurality of pieces of order data are picked from one rack (for example, the ratio of simultaneous picking from one rack: simultaneous picking ratio) is improved. Note that “simultaneous” does not mean that the times are strictly coincident timewise, but means that the products can be picked from the same single rack. The determination unit 103 determines the processing sequence of the plurality of pieces of order data such that turns are closer as the calculated distance is smaller. The determination unit 103 executes hierarchical (agglomerative) clustering that generates clusters represented by a hierarchical structure by repeating the processing of merging the orders corresponding to the indexes with small distances into a cluster, for example. The determination unit 103 then determines the processing sequence of the orders such that the orders in the same cluster are placed in close turns from each other.

As for the hierarchical clustering, the processing of finding a pair of two clusters with the smallest distance between the indexes assigned to the clusters and merging them into one cluster is iterated until all pieces of order data are merged into one cluster. This allows clustering of the plurality of pieces of order data such that the orders with the close distance between the corresponding indexes are included in the same cluster.

The determination unit 103 stores a binary tree with clusters (or orders) before being merged as child nodes (child clusters) and the cluster after being merged as a parent node (parent cluster) in the cluster data storage unit 123 as a clustering history. The determination unit 103 also stores clusters in a hierarchical structure representing the result of current clustering in the cluster data storage unit 123. When all pieces of order data are merged into a single cluster, a hierarchical cluster representing the final processing result is stored in the cluster data storage unit 123. By recursively expanding the above binary tree such that child clusters belonging to the same parent cluster are adjacent to each other, the determination unit 103 determines the processing sequence of the orders such that the leaves (corresponding to the order data) of the binary tree belonging to the same parent cluster are arranged in close turns.

The output control unit 105 controls the output of various kinds of information processed by the information processing device 100. For example, the output control unit 105 outputs information indicating the determined processing sequence of the orders (order sequence information), information indicating the racks to be used (assigned) for each order, and output information that includes information indicating the calling sequence of the racks for each of the orders (rack sequence information). The output information is referred to when allocating the orders to one or more work stations 11, for example.

When a plurality of work stations 11 are provided, the output control unit 105 may output a set of order data to be allocated to each of the work stations 11, and a set of racks to be assigned. The output control unit 105 divides a list of orders arranged in the processing sequence determined by the determination unit 103 such that the estimated amount of workload at each station is leveled, and outputs each of those. For example, there may be methods such as dividing the orders such that number of orders becomes equivalent, dividing the orders such that the total number of products in the orders becomes equivalent, dividing the orders such that the number of racks to be used becomes equivalent, and the like.

At least part of each of the above units (the reception unit 101, the priority calculation unit 102, the determination unit 103, the distance calculation unit 104, and the output control unit 105) may be achieved by a single processing unit. Each of the above units is achieved by one or more hardware processors, for example. For example, each of the above units may be achieved by having a processor such as a central processing unit (CPU) execute a computer program, that is, by software. Each of the above units may be achieved by a processor such as a dedicated integrated circuit (IC), that is, by hardware. Each of the above units may be achieved by using a combination of software and hardware. When using a plurality of processors, each of the processors may achieve one of the units or may achieve two or more of the units.

The order data storage unit 121 stores the order data received by the reception unit 101. The rack data storage unit 122 stores the rack data received by the reception unit 101. The cluster data storage unit 123 stores data (indexes, binary trees as history, hierarchical clusters, and the like) generated by the hierarchical clustering performed by the determination unit 103.

Each of the storage units (the order data storage unit 121, the rack data storage unit 122, and the cluster data storage unit 123) may be configured with any commonly used storage media such as a flash memory, a memory card, a Random Access Memory (RAM), a Hard Disk Drive (HDD), and an optical disk.

Each of the storage units may be a physically different storage medium or may be achieved as a different memory area of a physically same storage medium. Furthermore, each of the storage units may be achieved by a plurality of physically different storage media.

Next, details of the index generation method will be described. The determination unit 103 generates, for each order data, an index indicating the rack determined as the rack where the product is to be picked. FIG. 3 is a diagram illustrating an example of the index to be generated. FIG. 3 illustrates examples of the index generated for the order of the corresponding ID next to each order ID. The index may include information indicating the calling sequence of the rack. For example, the index may be generated to arrange the rack IDs from left to right according to the calling sequence. It is also possible to generate the index in which the rack ID and the information indicating the calling sequence are associated.

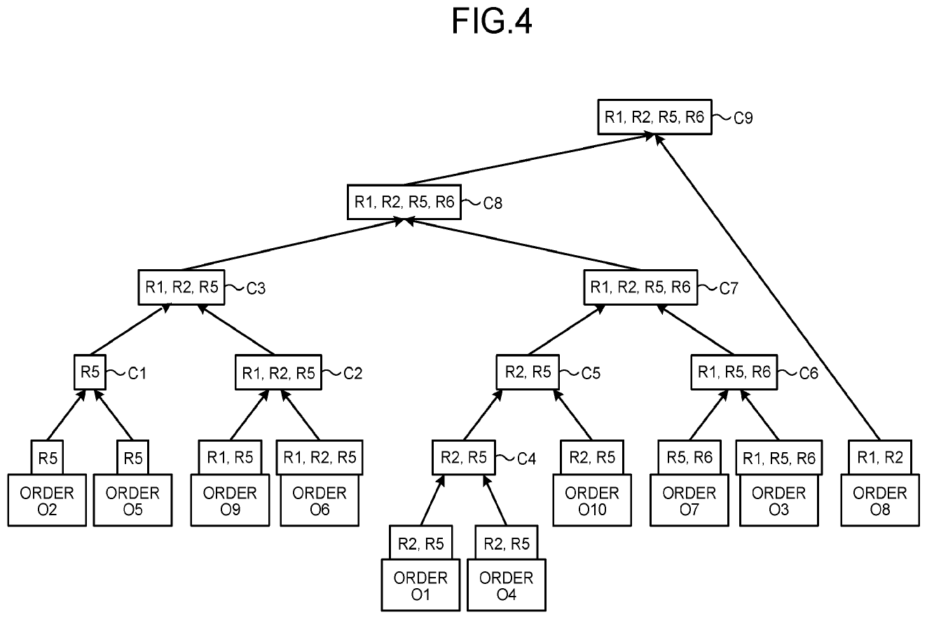

Next, an example of hierarchical clustering using indexes will be described. FIG. 4 is a diagram illustrating an example of hierarchical clusters to be generated by hierarchical clustering.

First, the distance calculation unit 104 calculates the distance between a plurality of generated indexes. The distance calculation unit 104 calculates, as the distance, the total number of unmatching racks (rack IDs) between two indexes, for example. Not limited thereto, the distance may be calculated by following methods, for example, and there is no limit set for the calculation method.
The distance is defined as the value acquired by multiplying the total number of matching racks by a negative coefficient.
The distance is the value of the sum of the total number of unmatching racks and the total number of matching racks, each multiplied by a coefficient.
When the index is weighted for each rack, the sum total of the weights (may be weights multiplied by a negative coefficient) may be used as the distance for each matching rack. For example, when the weight of the rack R5 included in the index of the order O1 in FIG. 3 is “2” and the weight of the rack R2 is “1”, the distance calculation unit 104 calculates the distance as “−2” when only the rack R5 matches, the distance as “−1” when only the rack R2 matches, and the distance as “−3” when the rack R5 and the rack R2 both match.

Next, the determination unit 103 generates clusters in a hierarchical structure by repeating the processing of merging the orders with the indexes of a small distance into one cluster, or clusters into one cluster, or an order and a cluster into one cluster. In FIG. 3, the indexes of the orders with the order IDs order O2 and order O5 match in respect that those indexes include only R5, for example. When using distances that have smaller values for the indexes including only the matching rack IDs, the determination unit 103 merges the orders with the order IDs order O2 and order O5 into a single cluster.

Cluster C1 in FIG. 4 indicates the cluster merged in this manner. Note that C1 to C9 represent information that identifies each cluster. The determination unit 103 stores a binary tree with the two indexes before being merged as child nodes and the cluster after being merged as a parent node in the cluster data storage unit 123. In a similar manner, the determination unit 103 iterates the processing until all orders are merged into a single cluster.

FIG. 4 illustrates an example of a single integrated cluster. As illustrated in FIG. 4, as the index for the merged cluster, the union of the rack IDs assigned to each order belonging to the cluster is used, for example.

Then, by recursively expanding the binary tree such that the child clusters belonging to the same parent cluster are adjacent to each other, the determination unit 103 determines the processing sequence of the orders such that the two orders corresponding to leaf nodes belonging to the same cluster are arranged in close turns.

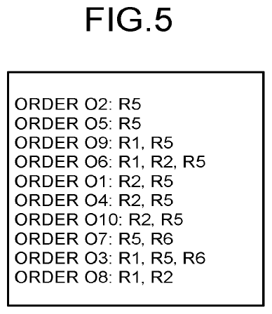

FIG. 5 is a diagram illustrating an example of orders rearranged according to the determined processing sequence. FIG. 5 is an example of orders rearranged based on the clusters illustrated in FIG. 4. As illustrated in FIG. 4, the clusters include ten leaf nodes corresponding to ten orders. The determination unit 103 determines the processing sequence of the orders by recursively following the parent-child relationship of the binary tree (expanding the binary tree) from the cluster C9 discovered at last, for example. In the example of FIG. 4, the determination unit 103 rearranges the orders according to the sequence of FIG. 5 by following the parent-child relationship in a manner as follows and arranging the reached leaves (orders).
C9→C8→C3→C1→order O2→C1→order O5→C1→C3→C2→order O9→C2→order O6→C2→C3→C8→C7→C5→C4″order O1→(omitted)→C8→C9→order O8

As described above, the output control unit 105 may output data groups of order data to be assigned to each of the work stations 11. For example, when there are N-pieces of work stations 11 (N is an exponent of 2 or larger), the output control unit 105 divides the order data into N-pieces of data groups such that the estimated workload of each of the work stations 11 is leveled. The output control unit 105 can use the following dividing methods.
Divide the order data such that the number of orders becomes equivalent.
Divide the order data such that the total number of products included in the orders becomes equivalent.
Divide the order data such that the total number of racks to be used in the orders (the size of the union of rack IDs included in the indexes) becomes equivalent.

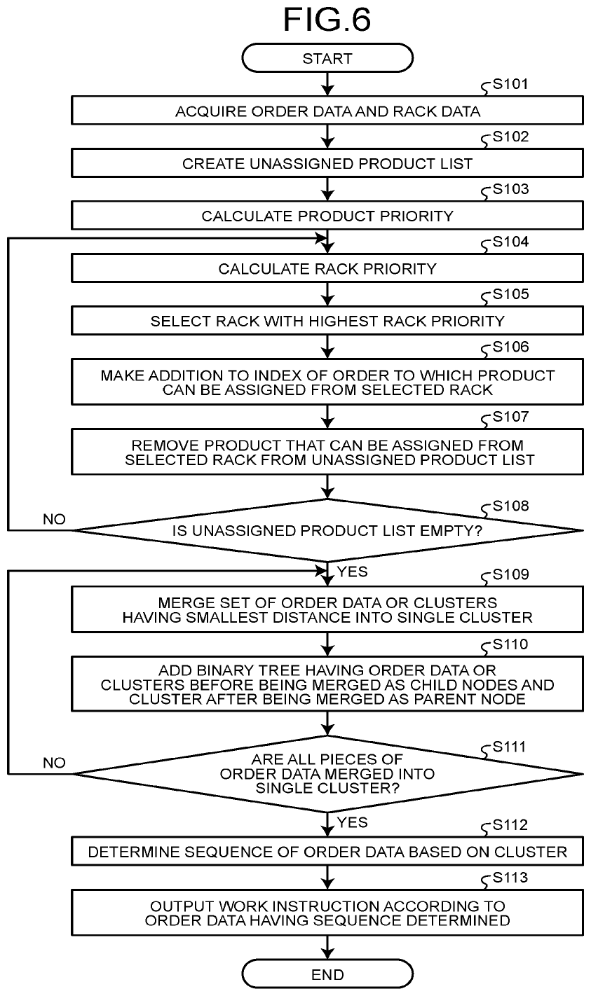

Next, the sequence determination processing performed by the information processing device 100 according to the present embodiment will be described. FIG. 6 is a flowchart illustrating an example of the sequence determination processing according to the present embodiment.

The reception unit 101 receives input of a plurality of pieces of order data and a plurality of pieces of rack data (step S101). The plurality of pieces of order data may be acquired by extracting unprocessed order data from the list of input orders.

From the received rack data, the determination unit 103 creates a list of products included in any of a plurality of pieces of order data, that is a list of products included in any of the plurality of pieces of order data, that is, a list (unassigned product list) of the products (unassigned products) that are not assigned despite of being requested (step S102).

Next, for unassigned products, the priority calculation unit 102 calculates the priority (product priority) for each product (step S103). For example, the priority calculation unit 102 counts the number of assigned orders for each product (the number of orders requesting the product), and calculates the counted value as the product priority.

Steps S104 through S108 are calculations iterated while updating the list of unassigned products. First, for each rack, the determination unit 103 calculates the total value of the product priorities of the products that are included in the corresponding rack data and in the unassigned product list, and uses it as the rack priority of the rack (step S104).

The determination unit 103 selects the rack with the highest priority (step S105). The determination unit 103 adds the rack ID of the selected rack to the indexes for all orders to which assignment from the selected rack is possible, among the unprocessed order data (step S106). The determination unit 103, for example, generates the indexes such that the added sequence is the calling sequence.

The determination unit 103 removes the assigned product from the unassigned product list (step S107). The determination unit 103 determines whether the unassigned product list is empty (step S108). If it is not empty (No at step S108), the processing returns to step 5104 and is repeated therefrom using the updated unassigned product list.

If the unassigned product list is empty (Yes at step S108), hierarchical clustering is performed at subsequent steps S109 through S111.

The determination unit 103 merges a pair of orders or clusters with the smallest distance into a single cluster (step S109). Note that the distance between the indexes is calculated by the distance calculation unit 104. The determination unit 103 generates a binary tree with orders or clusters before being merged as child nodes and a cluster after being merged as a parent node, and stores it in the cluster data storage unit 123 (step S110).

The determination unit 103 determines whether all orders are merged into a single cluster (step S111). If all orders are not merged into a single cluster (No at step S111), the processing returns to step S109 and is repeated therefrom.

If all orders are merged into a single cluster (Yes at step S111), the determination unit 103 determines the sequence of the order data based on the generated clusters (step S112).

The output control unit 105 outputs a work instruction based on the order data for which the sequence is determined and the racks to be used for each order (step S113). When there are a plurality of work stations, the output control unit 105 divides the list of a plurality of plurality of pieces of order data having sequence determined and information (indexes) regarding the racks to be used for each order and the calling sequence into a plurality of data groups, and outputs the data groups as information indicating the orders to be processed by each of the work stations 11.

The output control unit 105 may use the fact that the simultaneous picking ratio is calculated for each rack in the process of the processing for determining the racks to calculate at least one selected from the number of times of picking work required on each rack and the overall work time predicted value, and output the calculated result along with the information of the racks where each of the products included in the order data is picked.

For example, the simultaneous picking ratio for a rack is the number of kinds of products that can be picked simultaneously for a plurality of orders from that rack. In that case, the number of times of picking work can be calculated as the same value as the simultaneous picking ratio. The time for picking work can be calculated, for example, by the product of the number of times of picking work and the unit time. The unit time represents an amount of time defined in advance for one-time picking work.

As described, in the present embodiment, by using a plurality of pieces of order data and a plurality of pieces of rack data acquired in advance, it is possible to determine the processing sequence of the plurality of pieces of order data, the racks to be used for each order, and the calling sequence to be able to execute picking work more efficiently.

Furthermore, in the present embodiment, the racks to be used for each order and the calling sequence of the racks are determined by assuming that all orders can be processed in parallel and iterating to sequentially select the rack of the highest simultaneous picking ratio. Thus, the simultaneous picking ratio can be further improved.

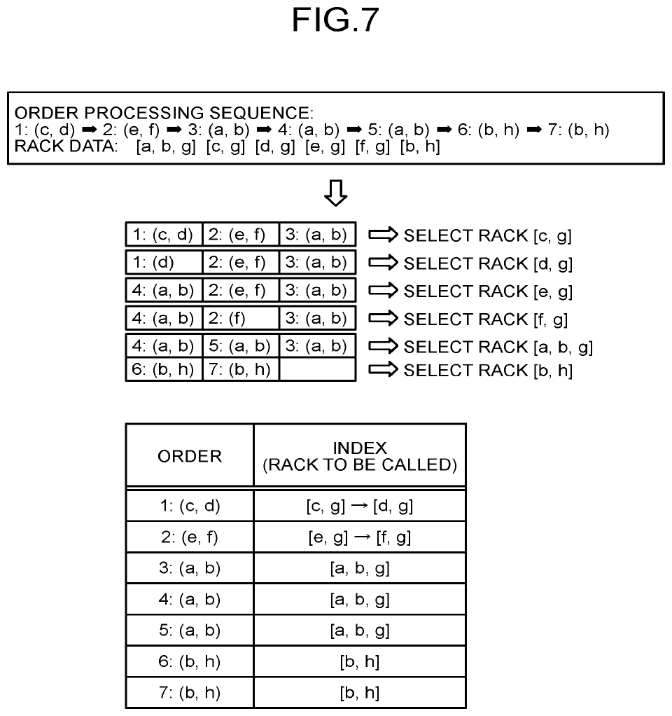

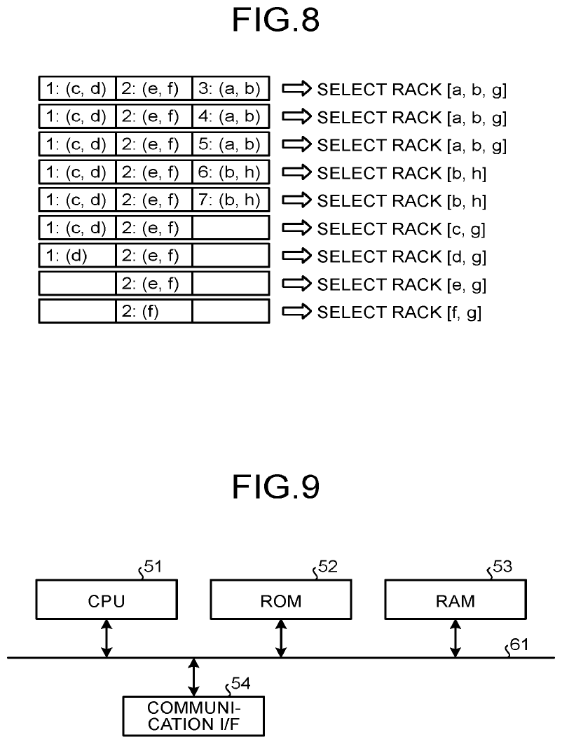

FIG. 7 is a diagram for describing a specific example of processing when determining in advance the racks to be used by the method of the present embodiment. FIG. 8 is a diagram for describing a comparative example where racks to be used are not determined in advance. The comparative example is, for example, a method (real-time rack selection method) that does not determine in advance racks to be used when determining the processing sequence of order data, and iterates to sequentially select the rack with the highest simultaneous picking ratio when executing picking work.

FIG. 7 and FIG. 8 illustrate examples where the processing sequence of the orders is determined as follows.
1: (c, d)→2: (e, f)→3: (a, b)→4: (a, b)→5: (a, b)→6: (b, h)→7: (b, h)

The numerical values represent the processing sequence, and the alphabet letters represent the identification information of the products included in each order. For example, “1 (c, d)” indicates that the first order in the processing sequence includes products of identification information c and d.

Furthermore, rack data as follows is used in FIG. 7 and FIG. 8. The alphabet letters represent the identification of the products on each rack.
{a, b, g}, {c, g}, {d, g}, {e, g}, {f, g}, {b, h}

Furthermore, in FIG. 7 (the method of the present embodiment), it is assumed that the racks and the rack calling sequence are determined as follows for each order. As described, in FIG. 7 (the method of the present embodiment), the racks to be used and the use sequence are determined in advance for each order.
1: (c, d): {c, g}→{d, g}
2: (e, f): {e, g}→{f, g}
3: (a, b): {a, b, g}
4: (a, b): {a, b, g}
5: (a, b): {a, b, g}
6: (b, h): {b, h}
7: (b, h): {b, h}

FIG. 7 and FIG. 8 also illustrate examples where three orders can be processed in parallel at the time of picking work When it is configured to call a rack according to the order processing sequence at the time of picking work, three housing containers 12 corresponding to three orders are set on the rack 13 for work.

In FIG. 7 (the method of the present embodiment), first, the orders from the first to third in the processing sequence, which are the orders 1: (c, d), 2: (e, f), and 3: (a, b), are the processing targets. In regard to the order 1 (c, d), the rack of the first calling sequence is {c, g}. Therefore, the rack {c, g} is selected and the product c is picked from the rack. Since the product d is left out of the order 1 (c, d), the rack {d, g} of the second calling sequence is selected and the product d is picked. In this manner, orders and racks are selected sequentially according to the order processing sequence and calling sequence, and picking work is performed. In this example, the picking work is completed in six rack moves as follows.
{c, g}→{d, g}→{e, g}→{f, g}→{a, b, g}→{b, h}

The comparative example in FIG. 8 is in common with FIG. 7 in respect that the orders 1: (c, d), 2: (e, f), and 3: (a, b) are the first processing targets. However, the comparative example is a method that selects the rack with the highest simultaneous picking ratio. Therefore, the rack {a, b, g} with the highest simultaneous picking ratio is selected first. This is because the products a and b included in 3: (a, b) can be picked simultaneously.

The housing container 12 corresponding to the order 3: (a, b) for which all products are picked is moved from the rack 13. The rack {a, b, g} where picking for the order 3: (a, b) is completed is moved from the work station 11 to other locations.

A new order 4: (a, b) of the next processing sequence is placed on the rack 13. At this point, the orders 1: (c, d), 2: (e, f), and 4: (a, b) are the processing targets. Among those processing targets, the rack with the highest simultaneous picking ratio is the order 4: (a, b), so that the rack {a, b, g} is selected again.

By repeating such processing, the racks are moved for a total of nine times in the comparative example in FIG. 8.

When the order processing sequence is determined by clustering, the processing sequence may be determined such that orders that use similar racks are grouped together, which may result in a high simultaneous picking ratio with some of the orders belonging to the boundaries of the clusters being processed in parallel. Therefore, with a method such as the method of the comparative example, which sequentially selects the racks with high simultaneous picking ratio, similar racks are called repeatedly, which may cause an increase in the number of times the racks are moved, as described above.

In the meantime, in the present embodiment, the racks to be used for each order are determined in advance, so that it is possible to suppress an increase in the number of times the racks are moved. That is, it is possible to execute picking work more efficiently.

Next, the hardware configuration of the information processing device according to the present embodiment will be described by referring to FIG. 9. FIG. 9 is a diagram illustrating an example of the hardware configuration of the information processing device according to the present embodiment.

The information processing device according to the present embodiment includes a control device such as a CPU 51, memory devices such as a Read Only Memory (ROM) 52 and a RAM 53, a communication I/F 54 that is connected to a network for performing communication, and a bus 61 that connects each of the units.

The computer program to be executed by the information processing device according to the present embodiment is provided by being loaded in advance in the ROM 52 or the like.

The computer program to be executed by the information processing device according to the present embodiment may be recorded in an installable or executable format file on a computer readable recording medium such as a Compact Disk Read Only Memory (CD-ROM), a flexible disk (FD), a Compact Disk Recordable (CD-R), a Digital Versatile Disk (DVD), or the like, and may be provided as a computer program product.

Furthermore, the computer program to be executed by the information processing device according to the present embodiment may be stored on a computer connected to a network such as the Internet and may be provided by being downloaded via the network. The computer program executed by the information processing device according to the present embodiment may be provided or distributed via a network such as the Internet.

The computer program executed by the information processing device according to the present embodiment may cause the computer to function as each of the units of the information processing device described above. As for the computer, the CPU 51 can read the computer program from a computer-readable storage medium and execute it on the main memory.

Configuration Examples of the embodiment are described below:

### Configuration Example 1

An information processing device including a processing unit configured to, based on a plurality of pieces of rack data including first identification information of one or more kinds of products housed in each of a plurality of racks, determine: a processing sequence of a plurality of pieces of order data including second identification information of one or more kinds of products to be picked from at least part of the plurality of racks; and one or more of the plurality of racks for picking a product identified by the second identification information for each of the plurality of pieces of order data.

### Configuration Example 2

The information processing device according to Configuration Example 1, wherein the processing unit is configured to
for each of the plurality of racks, calculate a higher priority as a number of pieces of first identification information that matches the second identification information included in the plurality of pieces of order data is greater, and
for the order data including the second identification information that matches the first identification information included in a rack selected in sequence from a highest priority, determine the selected rack as the one or more of the plurality of racks for picking the product identified by the second identification information.

### Configuration Example 3

The information processing device according to Configuration Example 1 or 2, wherein the processing unit is configured to further output information indicating at least one selected from: a number of picking works for each of the plurality of racks; and time for the picking works, which are calculated based on a ratio at which the products assigned to the order data are picked from a single rack.

### Configuration Example 4

The information processing device according to any one of Configuration Examples 1 to 3, wherein the processing unit is configured to generate, respectively for the plurality of pieces of order data, indexes each indicating one or more racks for picking the products among racks housing products of the first identification information that matches the second identification information, based on a priority calculated for each of the plurality of racks, and determine the processing sequence using the generated indexes.

### Configuration Example 5

The information processing device according to Configuration Example 4, wherein the processing unit is configured to
calculate distances between the indexes generated respectively for the plurality of pieces of order data, and
determine the processing sequence such that turns are closer as a calculated distance is smaller.

### Configuration Example 6

The information processing device according to Configuration Example 5, wherein the processing unit is configured to determine the processing sequence by executing hierarchical clustering in which processing of merging the order data corresponding to indexes with a small distances into a cluster are repeated, and performing recursive expansion such that child clusters having a common parent cluster are adjacent to each other.

### Configuration Example 7

The information processing device according to any one of Configuration Examples 1 to 6, wherein the processing unit includes a determination unit configured to determine the processing sequence, and the one or more of the plurality of racks for picking the product identified by the second identification information for each of the plurality of pieces of order data.

### Configuration Example 8

The information processing device according to any one of Configuration Examples 1 to 7, wherein the processing unit is configured to output the processing sequence, and the one or more of the plurality of racks determined for each of the plurality of pieces of order data.

### Configuration Example 9

The information processing device according to any one of Configuration Examples 1 to 8, wherein the plurality of racks are movable to a work station where housing containers corresponding to each of at least part of the plurality of pieces of order data are disposed.

### Configuration Example 10

The information processing device according to any one of Configuration Examples 1 to 9, wherein the processing unit is configured to determine, based on the plurality of pieces of rack data, the processing sequence and the one or more of the plurality of racks for picking the product identified by the second identification information for each of the plurality of pieces of order data such that a ratio at which the products assigned to the plurality of pieces of order data are picked from a single rack is improved.

### Configuration Example 11

An information processing method executed by the information processing device, the information processing method comprising, based on a plurality of pieces of rack data including first identification information of one or more kinds of products housed in each of a plurality of racks, determining: a processing sequence of a plurality of pieces of order data including second identification information of one or more kinds of products to be picked from at least part of the plurality of racks; and one or more of the plurality of racks for picking a product identified by the second identification information for each of the plurality of pieces of order data.

### Configuration Example 12

A computer program causing a computer to execute, based on a plurality of pieces of rack data including first identification information of one or more kinds of products housed in each of a plurality of racks, determining: a processing sequence of a plurality of pieces of order data including second identification information of one or more kinds of products to be picked from at least part of the plurality of racks; and one or more of the plurality of racks for picking a product identified by the second identification information for each of the plurality of pieces of order data.

### Configuration Example 13

An information processing system including: a transfer device, an information processing device, and a work station, wherein
the transfer device is configured to transfer a plurality of racks housing products to the work station, and
the information processing device includes a processing unit configured to, based on a plurality of pieces of rack data including first identification information of one or more kinds of products housed in each of the racks, determine: a processing sequence of a plurality of pieces of order data including second identification information of one or more kinds of products to be picked from at least part of the plurality of racks; and one or more of the plurality of racks for picking a product identified by the second identification information for each of the plurality of pieces of order data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising
one or more hardware processors configured to, based on a plurality of pieces of rack data including first identification information of one or more kinds of products housed in each of a plurality of racks, determine: a processing sequence of a plurality of pieces of order data including second identification information of one or more kinds of products to be picked from at least part of the plurality of racks; and one or more of the plurality of racks for picking a product identified by the second identification information for each of the plurality of pieces of order data.

2. The device according to claim 1, wherein the one or more hardware processors are configured to
for each of the plurality of racks, calculate a higher priority as a number of pieces of first identification information that matches the second identification information included in the plurality of pieces of order data is greater, and
for the order data including the second identification information that matches the first identification information included in a rack selected in sequence from a highest priority, determine the selected rack as the one or more of the plurality of racks for picking the product identified by the second identification information.

3. The device according to claim 1, wherein the one or more hardware processors are configured to further output information indicating at least one selected from: a number of picking works for each of the plurality of racks; and time for the picking works, which are calculated based on a ratio at which the products assigned to the order data are picked from a single rack.

4. The device according to claim 1, wherein the one or more hardware processors are configured to generate, respectively for the plurality of pieces of order data, indexes each indicating one or more racks for picking the products among racks housing products of the first identification information that matches the second identification information, based on a priority calculated for each of the plurality of racks, and determine the processing sequence using the generated indexes.

5. The device according to claim 4, wherein the one or more hardware processors are configured to
calculate distances between the indexes generated respectively for the plurality of pieces of order data, and
determine the processing sequence such that turns are closer as a calculated distance is smaller.

6. The device according to claim 5, wherein the one or more hardware processors are configured to determine the processing sequence by executing hierarchical clustering in which processing of merging the order data corresponding to indexes with a small distances into a cluster are repeated, and performing recursive expansion such that child clusters having a common parent cluster are adjacent to each other.

7. The device according to claim 1, wherein the one or more hardware processors are configured to implement a determination unit configured to determine the processing sequence, and the one or more of the plurality of racks for picking the product identified by the second identification information for each of the plurality of pieces of order data.

8. The information processing device according to claim 1, wherein the one or more hardware processors are configured to output the processing sequence, and the one or more of the plurality of racks determined for each of the plurality of pieces of order data.

9. The device according to claim 1, wherein the plurality of racks are movable to a work station where housing containers corresponding to each of at least part of the plurality of pieces of order data are disposed.

10. The device according to claim 1, wherein the one or more hardware processors are configured to determine, based on the plurality of pieces of rack data, the processing sequence and the one or more of the plurality of racks for picking the product identified by the second identification information for each of the plurality of pieces of order data such that a ratio at which the products assigned to the plurality of pieces of order data are picked from a single rack is improved.

11. An information processing method executed by the information processing device, the information processing method comprising, based on a plurality of pieces of rack data including first identification information of one or more kinds of products housed in each of a plurality of racks, determining: a processing sequence of a plurality of pieces of order data including second identification information of one or more kinds of products to be picked from at least part of the plurality of racks; and one or more of the plurality of racks for picking a product identified by the second identification information for each of the plurality of pieces of order data.

12. A computer program product comprising a computer-readable medium including programmed instructions, the instructions causing a computer to execute, based on a plurality of pieces of rack data including first identification information of one or more kinds of products housed in each of a plurality of racks, determining: a processing sequence of a plurality of pieces of order data including second identification information of one or more kinds of products to be picked from at least part of the plurality of racks; and one or more of the plurality of racks for picking a product identified by the second identification information for each of the plurality of pieces of order data.

13. An information processing system comprising: a transfer device, an information processing device, and a work station, wherein
the transfer device is configured to transfer a plurality of racks housing products to the work station, and
the information processing device includes one or more hardware processors configured to, based on a plurality of pieces of rack data including first identification information of one or more kinds of products housed in each of the racks, determine: a processing sequence of a plurality of pieces of order data including second identification information of one or more kinds of products to be picked from at least part of the plurality of racks; and one or more of the plurality of racks for picking a product identified by the second identification information for each of the plurality of pieces of order data.
